(19) United States
(12) Patent Application Publication
(10) Pub. No.: US 2017/0009800 A1
(43) Pub. Date: Jan. 12, 2017

(54) APPARATUS FOR MANUALLY OPERATING CAR TRANSMISSION STATE

(71) Applicant: DAEDONG SYSTEM CO., LTD., Incheon (KR)

(72) Inventors: Ho Chul LEE, Incheon (KR); In Seob JU, Incheon (KR); Jin Ho BOK, Incheon (KR); Jung Jo LIM, Incheon (KR)

(21) Appl. No.: 15/204,544

(22) Filed: Jul. 7, 2016

(30) Foreign Application Priority Data
Jul. 8, 2015 (KR) 10-2015-0097188

(51) Int. Cl. F16C 1/14; F16H 59/02

(52) U.S. Cl. CPC F16C 1/14; F16H 59/02

(57) ABSTRACT

Provided is an apparatus for manually operating a transmission state of a car, the apparatus including a base member fixed on a frame of the car; and a manipulation lever having a side rotatably coupled to the base member via a hinge shaft and an opposite side rotating about the hinge shaft, and comprising a through hole, through which an end of an operating cable for manually operating the transmission state passes, and a fixing recess formed adjacent to the through hole for hooking and fixing the end of the operating cable, wherein the manipulation lever and the end of the operating cable are rotated together so as to shift the transmission state via the manual operation, connecting and separating of the operating cable and the manipulation lever is freely performed via the through hole, and the operating cable is fixed to the manipulation lever via the fixing recess.

### CROSS-REFERENCE TO RELATED APPLICATION

This application claims priority of Korean Patent Application No. 10-2015-0097188, filed on Jul. 8, 2015, in the Korean Intellectual Property Office, the disclosure of which is incorporated herein in its entirety by reference.

### BACKGROUND

1. Field

One or more embodiments relate to an apparatus for manually operating a transmission state of a car, and more particularly, to an apparatus for manually operating a transmission state of a car, which has an improved structure for manually shifting a transmission state of a car.

2. Description of the Related Art

In general, when a driver manipulates a gearshift inside a vehicle, power transfer between the gearshift and a transmission is made via a cable so as to shift a transmission state, and components that are necessary for driving and stopping the vehicle, such as an engine, are operated based on an electric signal corresponding to the transmission state.

For example, when a driver shifts the gearshift to a parking state and turns off the engine, after stopping the vehicle, an electric signal based on the parking state is transferred to the engine, and accordingly, engine does not ignite even when the driver starts the engine, provided that the parking state is maintained.

Hereinafter, an operation of changing speeds when the engine is operating is referred to as an automatic operation, and an operation of changing speeds when the engine does not operate (due to breakdown or battery discharge) is referred to as a manual operation.

The manual operation is required when the transmission state of a parking state P is manually changed to a neutral state N without power supply during, for example, breakdown or battery discharge.

An apparatus for allowing the manual operation is called as an apparatus for manually operating a car transmission state, and such an apparatus needs to be designed so that a driver may easily manipulate.

### SUMMARY

One or more embodiments include an apparatus for shifting a car transmission state through a manual operation, capable of improving user's convenience, achieving a simple structure, and requiring relatively less power that is necessary for forcedly shifting the transmission state from outside a car.

One or more embodiments includes an apparatus for shifting a car transmission state through a manual operation, capable of improving efficiency in replacing components by increasing assembling properties between components.

Additional aspects will be set forth in part in the description which follows and, in part, will be apparent from the description, or may be learned by practice of the presented embodiments.

According to one or more embodiments, an apparatus for shifting a transmission state of a car through a manual operation, the apparatus includes: a base member fixed on a frame of the car; and a manipulation lever having one side rotatably coupled to the base member via a hinge shaft and an opposite side rotating about the hinge shaft, and including a through hole, through which an end of an operating cable for manually operating the transmission state passes, and a fixing recess formed adjacent to the through hole for hooking and fixing the end of the operating cable, wherein the manipulation lever and the end of the operating cable are rotated together so as to shift the transmission state via the manual operation, connection and disconnection between the operating cable and the manipulation lever are freely performed via the through hole, and the operating cable is fixed to the manipulation lever via the fixing recess.

The manipulation lever may include a guide slit disposed between the through hole and the fixing recess so that the operating cable that passed through the through hole moves toward the fixing recess.

The guide slit may include an escape prevention portion for preventing the operating cable from escaping from the fixing recess and moving toward the through hole in an opposite direction to an insertion path of the operating cable in a state where an external operating force is not applied, when the operating cable is inserted to the fixing recess after passing through the guide slit.

According to one or more embodiments, an apparatus of manually operating a transmission state of a car, the apparatus includes: a base member fixed to a frame of the car; and a manipulation lever connected to the base member, and including a through hole, through which an end of an operating cable for manually operating the transmission state passes, and a fixing recess formed adjacent to the through hole for hooking and fixing the end of the operating cable, wherein the operating cable is operated with the manipulation lever so as to shift the transmission state via the manual operation, connecting and separating of the operating cable and the manipulation lever is freely performed via the through hole, and the operating cable is configured to be fixed to the manipulation lever via the fixing recess.

### BRIEF DESCRIPTION OF THE DRAWINGS

These and/or other aspects will become apparent and more readily appreciated from the following description of the embodiments, taken in conjunction with the accompanying drawings in which:

FIG. 1 is a perspective view of an apparatus for manually operating a car transmission state, according to an embodiment;

FIG. 2 is a perspective view of the apparatus for manually operating the car transmission state of FIG. 1, seen from the other side;

FIG. 3 is an enlarged view of a portion III of FIG. 2;

FIG. 4 illustrates a state of use of the apparatus, according to an embodiment;

FIG. 5 is a reference view of a state in which a coupling is made by using a connection bracket, according to an embodiment; and

FIG. 6 is a side view of an apparatus for manually operating a transmission state of a car, according to another embodiment.

### DETAILED DESCRIPTION

Reference will now be made in detail to embodiments, examples of which are illustrated in the accompanying drawings, wherein like reference numerals refer to like elements throughout.

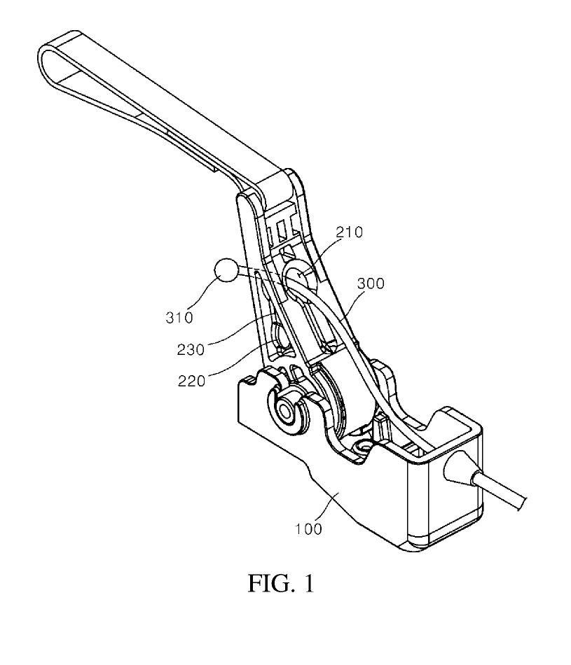

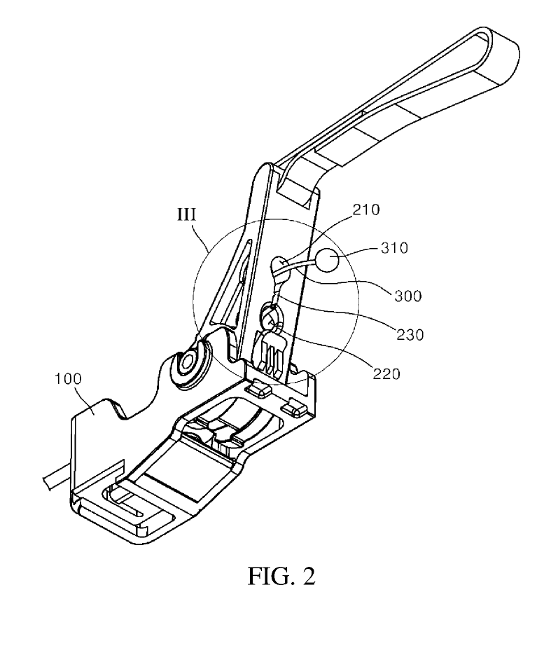

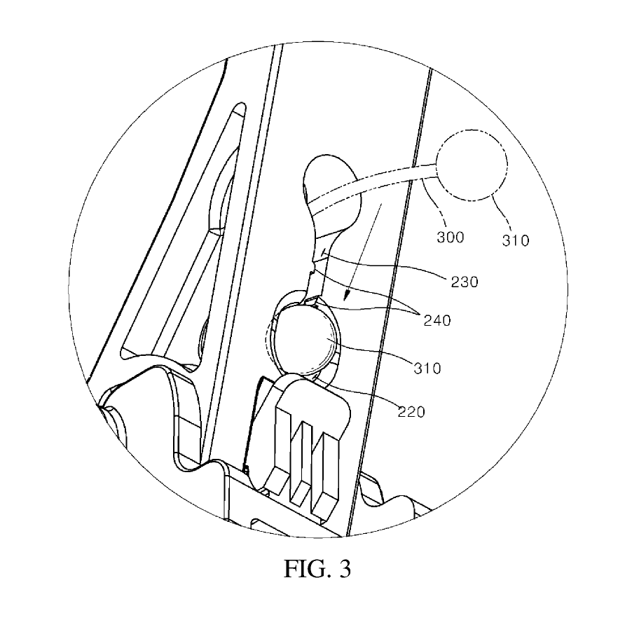

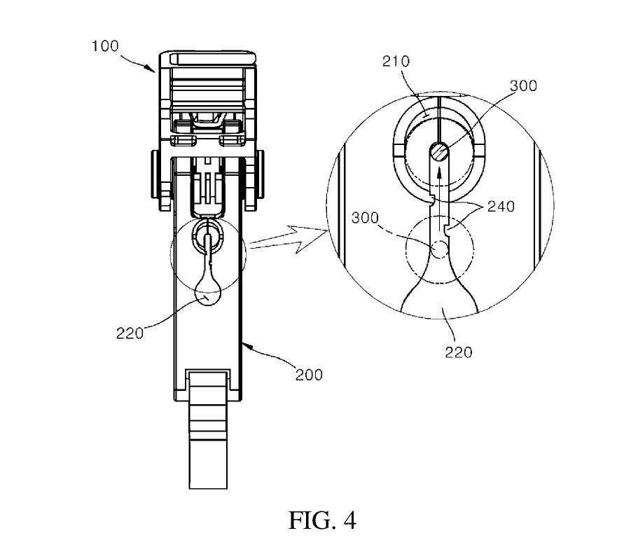

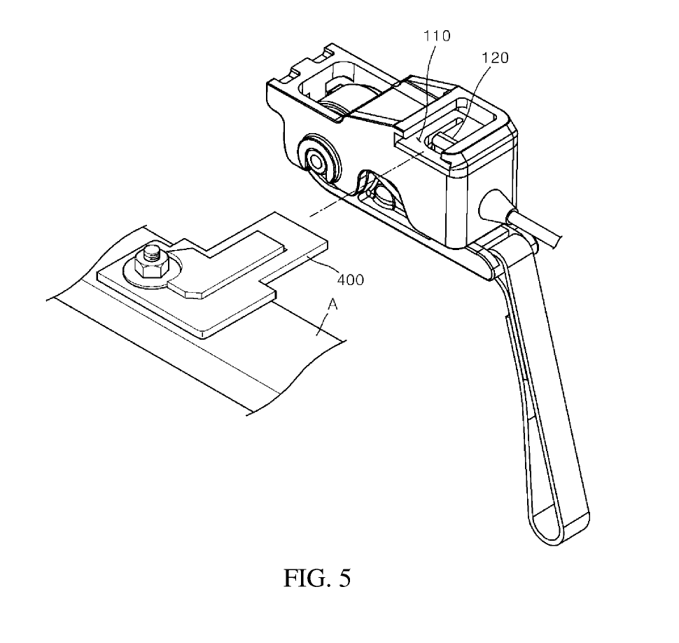

FIG. 1 is a perspective view of an apparatus for manually operating a car transmission state, according to an embodiment, FIG. 2 is a perspective view of the apparatus for manually operating the car transmission state of FIG. 1, seen from the other side, FIG. 3 is an enlarged view of a portion III of FIG. 2, FIG. 4 illustrates a state of use of the apparatus, according to an embodiment, and FIG. 5 is a reference view of a state in which a coupling is made by using a connection bracket, according to an embodiment.

As shown in the drawings, the apparatus for manually operating a car transmission state according to an embodiment is for shifting a transmission state of a car via a manual operation, and includes a base member 100 and a manipulation lever 200. The manipulation lever 200 includes a through hole 210 and a fixing recess 220.

The base member 100 is fixed to a frame A of a car, and according to the embodiment, the base member 100 is coupled to a part of the frame A of the car via a connection bracket 400, but is not limited thereto.

In addition, the manipulation lever 200 has a side that is rotatably coupled to the base member 100 via a hinge shaft, and the other side that is rotated about the hinge shaft, and includes the through hole 210, through which an end of an operating cable 300 for manually operating the transmission state passes, and the fixing recess 220 formed adjacent to the through hole 210 for hooking and fixing the end of the operating cable.

Therefore, according to the embodiment, the end of the operating cable 300 is rotated with the manipulation lever 200 in order to manually shift the transmission state, and connection and disconnection between the operating cable 300 and the manipulation lever 200 may be freely performed via the through hole 210. In addition, the operating cable 300 may be fixed to the manipulation lever via the fixing recess 220.

In addition, a connecting tool is coupled to the base member 100 in order to connect the operating cable 300 to the base member 100.

According to the embodiment, after rotating the manipulation lever 200 with respect to the base member 100 for manually operating the transmission state, a hook provided on the base member 100 is coupled to a hook recess formed in the manipulation lever 200 so as to fix the manipulation lever 200 to the base member 100.

Here, the operating cable 300 according to the embodiment includes a fixing member 310 provided integrally at an end portion thereof in order to be fixed to the manipulation lever 200.

If the manipulation lever 200 does not include the through hole 210, the operating cable 300 has to be fixed to the manipulation lever 200 before assembling the operating cable 300 with the fixing member 310, and then, the operating cable 300 and the fixing member 310 are assembled during manufacturing processes according to the embodiment. Thus, the number of processes for connecting the manipulation lever 200 to the operating cable 300 increases. Moreover, in order to fix the operating cable to the manipulation lever according to the prior art, the fixing operation has to be performed in a state where the operating cable 300 is located on the manipulation lever 200, and accordingly, productivity of the fixing operation degrades.

On the contrary, since the manipulation lever 200 includes the through hole 210 to which the fixing member 310 of the operating cable 300 may be inserted according to the embodiment, the operating cable 300 and the manipulation lever 200 may be assembled with each other in a state where the fixing member 310 is fixed on the end portion of the operating cable 300.

Therefore, productivity of assembling the operating cable 300 connected to the manipulation lever 200 may be improved.

In addition, when the operating cable 300 including the fixing member 310 is assembled, the fixing member 310 of the operating cable 300 is inserted to the through hole 210 of the manipulation lever 200, and is located at the fixing recess 220 to be fixed. Thus, the assembling may be performed effectively and the productivity of assembling the operating cable 300 may be improved.

According to the embodiment, the operating cable 300 may be easily coupled to the manipulation lever 200, and thus, replacement of the operating cable 300 and the manipulation lever 200 may be easily performed, and moreover, assembling properties between components may be improved so as to improve an efficiency of follow-up management of the apparatus.

The manipulation lever 200 according to the embodiment may include a guide slit 230 disposed between the through hole 210 and the fixing recess 220, so that the operating cable 300 that passed through the through hole 210 may move toward the fixing recess 220.

As described above, when the guide slit 230 is disposed between the through hole 210 and the fixing recess 220 of the manipulation lever 200 according to the embodiment, the operating cable 300 may move to the fixing recess 220 via the guide slit 230 after being inserted to the through hole 210 so as to be fixed in a state of being inserted in the fixing recess 220. Therefore, efficiency in assembling and disassembling the operation cable 300 may be improved.

In addition, the guide slit 230 according to the embodiment may include an escape prevention portion 240 as shown in FIG. 3.

As described above, when the guide slit 230 includes the escape prevention portion 240, escaping of the operating cable 300 from the fixing recess and moving toward the through hole 210 in an opposite way to the insertion path may be prevented in a state where an external operating force is not applied, after the operating cable 300 is inserted to the fixing recess 220 via the guide slit 230.

As shown in FIG. 5, the base member 100 according to the embodiment may include an insertion recess 110 and a position fixing step 120 for easily coupling the base member 100 and the frame A of the car to each other.

The insertion recess 110 is a recess to which a side of the frame A may be inserted, and according to the embodiment, the insertion recess 110 denotes a recess, to which the connection bracket 400 coupled to the frame A of the car is inserted, formed in a side of the base member 100.

In addition, the position fixing step 120 is elastically transformed while a side of the connection bracket 400 coupled to the frame A of the car is inserted to the insertion recess 110, and then, is elastically recovered to the original state in a state where the insertion of the connection bracket 400 into the insertion recess 110 is finished so as to be hooked by the side of the connection bracket 400.

Therefore, according to the base member 100 of the embodiment, the base member 100 may be connected to the frame A of the car, that is, to the connection bracket 400 coupled to the frame A of the car, by sliding towards the frame A, and accordingly, an efficiency of assembling and disassembling the base member 100 and the frame A of the car may be improved.

Moreover, according to the embodiment, the connection bracket 400 may be further provided for easily connecting the frame A of the car to the base member 100.

As described above, when the connection bracket 400 is further provided, the frame A of the car and the base member 100 including the insertion recess 110 and the position fix step 120 may be assembled with each other in a simple manner.

In addition, according to another embodiment, in order to shift a transmission state of a car via manual operation, the base member 100 and the manipulation lever 200 are provided, wherein the manipulation lever 200 includes the through hole 210 and the fixing recess 220.

The base member 100 is fixed to the frame A of the car, and is described to be coupled to a part of the frame A via the connection bracket 400, but is not limited thereto.

In addition, the manipulation lever 200 may not rotate about the hinge as described above according to the embodiment, and may be coupled to the base member 100 by sliding towards the base member 100.

The manipulation lever 200 is connected to the base member 100, and may include the through hole 210, through which an end of the operating cable 300 for manually operating the transmission state passes, and the fixing recess 220 formed adjacent to the through hole 210 for hooking and fixing the end of the operating cable 300.

As described above, the apparatus according to the embodiment may perform the basic function of the previous embodiment, that is, shifting the transmission state via the manual operation, and may freely perform connection and disconnection between the operating cable 300 and the manipulation lever 200 via the through hole 210, and moreover, the apparatus may be manufactured in a different operating manner from that of the previous embodiment.

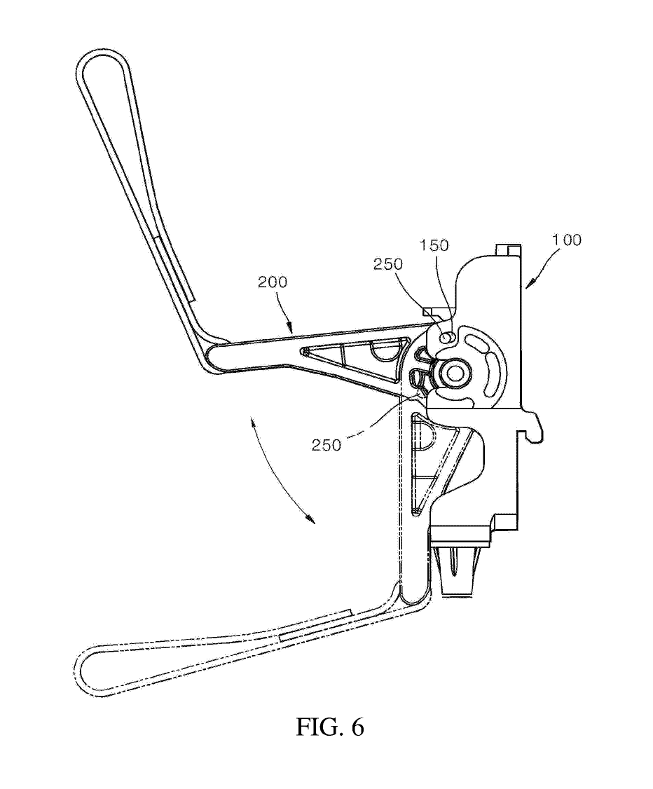

FIG. 6 is a side view of an apparatus for manually operating a transmission state of a car, according to another embodiment.

As shown in FIG. 6, the base member 100 and the manipulation lever 200 according to the embodiment rotate about a hinge.

Here, according to the embodiment, a fixing protrusion 250 is formed on a side surface of the manipulation lever 200, and the base member 100 includes a fixing protrusion recess 150 within a turning radius of the fixing protrusion 250 of the manipulation lever 200.

Therefore, the manipulation lever 200 is rotated with respect to the base member 100 for performing the manual operation in a state where the manipulation lever 200 is coupled to the base member 100. Meanwhile, the fixing protrusion 250 of the manipulation lever 200 is inserted to the fixing protrusion recess 150 of the base member 100 so that the manipulation lever 200 may be fixed on the base member 100.

The embodiment may further use an auxiliary fixing unit for fixing the manipulation lever 200 to the base member 100, in addition to the way of fixing the manipulation lever to the base member 100 by using the hook and the hook recess.

According to one or more embodiments, the transmission state of the car may be forcedly shifted only by rotating the manipulation lever, without using a tool for releasing the transmission state, and accordingly, driver's convenience may be improved and the simplification of a structure may be achieved.

In addition, according to one or more embodiments, the operating cable may be easily coupled to the manipulation lever so that replacing of the operating cable and the manipulation lever may be easily performed, and moreover, assembling properties between the components may be improved so as to improve efficiency in post-management.

While one or more embodiments have been described with reference to the figures, it will be understood by those of ordinary skill in the art that various changes in form and details may be made therein without departing from the spirit and scope of the inventive concept as defined by the following claims.

What is claimed is:

1. An apparatus for shifting a transmission state of a car through a manual operation, the apparatus comprising:
a base member fixed on a frame of the car; and
a manipulation lever having one side rotatably coupled to the base member via a hinge shaft and an opposite side rotating about the hinge shaft, and comprising a through hole, through which an end of an operating cable for manually operating the transmission state passes, and a fixing recess formed adjacent to the through hole for hooking and fixing the end of the operating cable,
wherein the manipulation lever and the end of the operating cable are rotated together so as to shift the transmission state via the manual operation, connection and disconnection between the operating cable and the manipulation lever are freely performed via the through hole, and the operating cable is fixed to the manipulation lever via the fixing recess.

2. The apparatus of claim 1, wherein the manipulation lever comprises a guide slit disposed between the through hole and the fixing recess so that the operating cable that passed through the through hole moves toward the fixing recess.

3. The apparatus of claim 2, wherein the guide slit comprises an escape prevention portion for preventing the operating cable from escaping from the fixing recess and moving toward the through hole in an opposite direction to an insertion path of the operating cable in a state where an external operating force is not applied, when the operating cable is inserted to the fixing recess after passing through the guide slit.

4. The apparatus of claim 1, wherein, in order to easily connect the base member to the frame of the car, the base member comprises an insertion recess, to which a side of the frame of the car is inserted, and a position fixing step that is elastically transformed while the side of the frame is inserted to the insertion recess and elastically recovered to be hooked by the side of the frame in a state where the insertion of the side of the frame to the insertion recess is finished, and
the base member is connected to the frame of the car by sliding toward the frame of the car.

5. The apparatus of claim 4, further comprising a connection bracket for easily connecting the frame of the car to the base member,
wherein the base member comprises an insertion recess to which a side of the connection bracket is inserted, and a position fixing step that is elastically transformed while the side of the connection bracket is inserted to the insertion recess and elastically recovered to be hooked by the side of the connection bracket in a state where the insertion of the side of the connection bracket to the insertion recess is finished

6. The apparatus of claim 1, wherein the manipulation lever comprises a fixing protrusion on a side surface thereof, and the base member comprises a fixing protrusion recess within a rotating radius of the manipulation lever so that the fixing protrusion of the manipulation lever is inserted to the fixing protrusion recess of the base member and the manipulation lever is fixed to the base member, when the manipulation lever is rotated with respect to the base member for performing the manual operation in a state where the manipulation lever is coupled to the base member.

7. An apparatus of manually operating a transmission state of a car, the apparatus comprising:
a base member fixed to a frame of the car; and
a manipulation lever connected to the base member, and comprising a through hole, through which an end of an operating cable for manually operating the transmission state passes, and a fixing recess formed adjacent to the through hole for hooking and fixing the end of the operating cable,
wherein the operating cable is operated with the manipulation lever so as to shift the transmission state via the manual operation, connecting and separating of the operating cable and the manipulation lever is freely performed via the through hole, and the operating cable is configured to be fixed to the manipulation lever via the fixing recess.
